(19) United States
(12) Patent Application Publication
(10) Pub. No.: US 2006/0012414 A1
(43) Pub. Date: Jan. 19, 2006

(54) Circuit and method for generating a polyphase clock signal and system incorporating the same

(75) Inventor: Stanley J. Goldman, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/891,651

(22) Filed: Jul. 15, 2004

(51) Int. Cl. G06F 1/04

(52) U.S. Cl. 327/291

(57) ABSTRACT

A circuit for, and method of, generating a polyphase clock signal and a synchronous data processing system incorporating the circuit or the method. In one embodiment, the circuit includes: (1) R-S latch delay elements connected in a ring and configured to generate a circulating sequence of logic signals and (2) phase taps, coupled to points between ones of the R-S latch delay elements and configured to tap the circulating sequence to provide the polyphase clock signal.

### TECHNICAL FIELD OF THE INVENTION

The present invention is directed, in general, to clock signal generation and, more specifically, to a circuit and method for generating a polyphase clock signal and a synchronous data processing system incorporating the circuit or the method.

### BACKGROUND OF THE INVENTION

Synchronous data processing requires a well defined clock signal of proper frequency and phase. Accordingly, generation and recovery of clock signals is important in various areas involving synchronous data processing, such as: communications, data storage and digital audio/video.

A phase-locked loop (PLL) is often used to generate clock signals. As well known in the art, a PLL is an electronic circuit that oscillates at a desired frequency and automatically adjusts the phase of its oscillation to match (“lock on”) that of an input signal. The PLL includes an oscillator, which is often a voltage controlled oscillator (VCO). A VCO typically includes inverters configured in a ring. An odd number of inverters is needed to oscillate.

In addition to the VCO, a conventional PLL may include a phase/frequency detector to convert a phase difference to a pulse width modulated (PWM) error signal, a charge pump and lag lead loop filter to convert the phase error to a control voltage and a buffer amplifier that converts the high impedance control voltage to a low impedance drive for a VCO tune line. The VCO converts the control voltage to an output phase. A programmable divider at the VCO output feeds the divided-down VCO phase back to the phase detector input to complete the loop.

Other PLLs provide a two-loop solution for clock signal generation. These PLLs include a coarse tuning loop having a VCO that locks to a crystal oscillator at an appropriate scaling factor. The output of the VCO is then provided to a fine tuning loop that selects a best phase from the VCO to match the input data stream.

PLLs with VCOs are also used for clock recovery. Clock recovery PLL applications require at least one in-phase output and one quadrature (90° out-of-phase) output from the VCO to recover the clock signal from a data stream input to a phase detector of the PLL. A quadrature output requires an even number of inverters. Accordingly, for recovery of clock signals, the VCO includes an additional delay element with the odd number of inverters.

Along with the VCO, clock recovery circuits often employ a phase/frequency detector for coarse frequency adjustment from the input data stream and another phase detector for fine-tune phase adjustment from the input data stream. Outputs from the two detectors are combined with coarse and fine charge pumps to drive lag lead filter components to generate a stable control voltage for the VCO. The VCO converts the control voltage to an output phase that drives a divide-by-two frequency divider. The output of the feedback divider drives the phase detector input to complete the fine tune loop and drives the input of another divide-by-two frequency divider. The output of the other divide-by-two frequency divider drives a phase lock detector and the coarse frequency detector, which completes the coarse loop adjustment for this clock recovery circuit.

Existing PLL and VCO-based clock generating and recovery circuits, however, prove inadequate in several ways. As mentioned above, the VCO is constructed from inverters that require an odd number for oscillation. Accordingly, a quadrature output requires additional hardware coupled to the VCO. Also, the PLLs that have coarse and fine tuning are often reliable on the accuracy of crystal oscillator frequency, for example, within 200 ppm, or the receive fine tuning loop has difficulty maintaining a lock because the range of the phase selections are too small to cancel out the higher phase error. Additionally, PLLs with coarse and fine tuning combine the tuning into a single control voltage. Moreover, existing PLLs operate at a high frequency, which consumes significant power.

Accordingly, what is needed in the art is an improved circuit for clock signal generation and recovery. More specifically, what is needed is an improved circuit and method for generating and recovering a clock signal that requires less power, less hardware and provides more stability over conventional clock generating and recovery circuits.

### SUMMARY OF THE INVENTION

To address the above-discussed deficiencies of the prior art, the present invention provides a circuit for generating a polyphase clock signal and a synchronous data processing system incorporating the circuit or the method. In one embodiment, the circuit includes: (1) R-S latch delay elements connected in a ring and configured to generate a circulating sequence of logic signals and (2) phase taps, coupled to points between ones of the R-S latch delay elements and configured to tap the circulating sequence to provide the polyphase clock signal.

The present invention, therefore, employs R-S latch delay elements in a ring oscillator to generate differential outputs instead of using inverters as in conventional voltage controlled oscillators (VCOs). The R-S latch delay elements allow an even number of gates, for example four, in the ring instead of an odd number of inverters to obtain oscillation. Thus, an even number of the R-S latch delay elements can provide a 90° output and an in-phase output.

In another aspect, the present invention provides a method of generating a polyphase clock signal. In one embodiment, the method includes: (1) generating a circulating sequence of logic signals with R-S latch delay elements connected in a ring and (2) tapping the circulating sequence to provide the polyphase clock signal.

In yet another aspect, the present invention provides a synchronous data processing system. In one embodiment, the circuit includes: (1) a polyphase clock circuit, having: (1a) R-S latch delay elements connected in a ring and configured to generate a circulating sequence of logic signals and (1b) phase taps, coupled to points between ones of the R-S latch delay elements and configured to tap the circulating sequence to provide a polyphase clock signal and (2) data processing circuitry coupled to the polyphase clock circuit and configured to receive an incoming data stream and employ the polyphase clock signal to process the incoming data stream synchronously.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic diagram of one embodiment of a circuit for generating a polyphase clock signal constructed according to the principles of the present invention;

FIG. 2 illustrates a flow diagram of one embodiment of a method of generating a polyphase clock signal carried out according to the principles of the present invention; and

FIG. 3 illustrates a block diagram of a synchronous data processing system incorporating the circuit of FIG. 1 or the method or FIG. 2.

### DETAILED DESCRIPTION

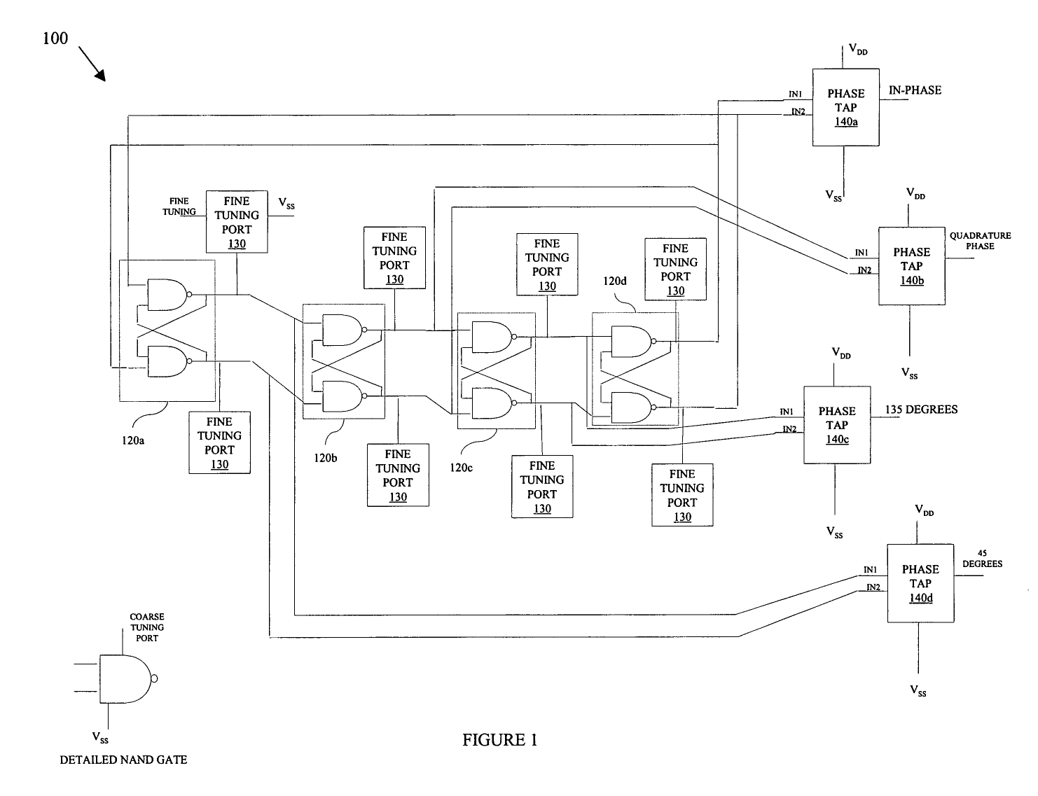

Referring initially to FIG. 1, illustrated is a schematic diagram of one embodiment of a circuit for generating a polyphase clock signal, generally designated 100, constructed according to the principles of the present invention. The circuit 100 includes four R-S latch delay elements 120a, 120b, 120c, 120d and four phase taps 140a, 140b, 140c, 140d. The above components may be called out by group instead of individually, in which case, they will be designated by numerals without the appended letters. The R-S latch delay elements 120a, 120b, 120c, 120d, for example, are designated as a group as R-S latch delay elements 120. The circuit 100 also includes eight fine tuning ports 130.

The circuit 100 is a voltage controlled oscillator (VCO) that may be employed to generate or recover a clock signal. In one embodiment, the circuit 100 may be employed in a cellular telephone to recover a degraded clock signal from an incoming data stream to synch data for processing. Unlike conventional VCOs, the circuit 100 advantageously employs the R-S latch delay elements 120 in an oscillator loop. Thus, instead of using inverters in a loop and a delay cell followed by a latch, the circuit 100 employs the R-S latch delay elements 120 as delays cells. Accordingly, the clock signal generated by the circuit 100 does not require an additional latch for cleaning.

The R-S latch delay elements 120 are connected in a ring and configured to generate a circulating sequence of logic signals. The circulating sequence covers a phase shift of 180° around the ring. Of course, in other embodiments, the phase shift provide by the circulating sequence around the ring may vary.

As those skilled in the pertinent art are familiar, the R-S latch delay elements 120 are cross-connected conventional NAND gates. Each of the NAND gates include a high and low supply voltage port. The high supply voltage port for each of the NAND gates is used as a coarse tuning port. An operational amplifier (opamp) (not shown) coupled to each coarse tuning port provides coarse tuning port control. In the illustrated embodiment, the opamp is conventional. Employing an output of an opamp for the coarse tuning port control reduces sensitivity of the R-S latch delay elements 120 thereto, since the R-S latch delay elements 120 are not directly coupled to the power supply. Additionally, the high Power Supply Rejection Ratio (PSRR) of the opamp determines the sensitivity to the voltage supply.

Employing the coarse tuning port control has several effects on the circuit 100. First, changing the coarse tuning port control changes a delay of each of the R-S latch delay elements 120 and, consequently, linearly changes an output frequency. Second, changing the coarse tuning port control reduces a maximum frequency response of the R-S latch delay elements 120. Reducing the maximum frequency response is advantageous because the circuit 100 becomes less sensitive to high frequency signals and less sensitive to exciting other oscillating modes. Third, changing the coarse tuning port control changes a logic swing of the circuit 100. A desirable high voltage swing occurs when the output frequency of the circuit 100 is the highest. Low voltage swings occur for low frequencies which reduce power consumption. An output level shift converts the low frequency low voltage swings to full logic levels.

Configuration of the R-S latch delay elements 120 makes the circuit 100 less sensitive to coupling. This is evident since the R-S latch delay elements 120 configuration is commonly used as a switch debounce circuit. Additionally, differential outputs of the R-S latch delay elements 120 allow a four delay ring oscillator instead of three or five delay elements that are used for inverter delay elements in prior art oscillators.

The fine tuning ports 130 are coupled to each of the R-S latch delay elements 120. The fine tuning ports 130 change an output impedance of the R-S latch delay elements 120 to slow or speed up the output frequency. The fine tuning ports 130 include an nmos transistor in series with a capacitor to vary the output impedance. Slightly varying the output impedance changes the delay of the R-S latch delay elements 120 and provides a fine tune method of changing the VCO frequency that is separate from the coarse tuning port control. Having a separate fine tuning port allows a significantly smaller VCO gain, for example, 1 MHz/V, which reduces the level of reference sidebands and therefore reduces jitter of the polyphase clock signal.

The phase taps 140, coupled to points between ones of said R-S latch delay elements 120 are configured to tap the circulating sequence to provide the polyphase clock signal. As illustrated, the phase taps 140 provide a quadrature phase component (140b) and an in-phase component (140a) of the polyphase clock signal. The other phase taps, 140c and 140d, provide additional 45° phase shifts.

A period of the clock signal generated by the circuit 100 is represented by Equation 1:
T₀=2MT_{d} (1)
where M=the number of stages and T_{d}=delay for each stage. One round trip around the ring produces 180° of phase shift. The total phase shift through the circuit 100 should be 360° with a gain of unity to meet the criterion for oscillation. Two round trips, therefore, occur for each period of oscillation. The factor of two difference in phase shift is represented by the factor of two in Equation 1.

Varying the delay term, T_{d}, in Equation 1 varies the output frequency of the circuit 100 f₀ (f₀=1/T₀) . The R-S latch delay elements 120 provide a 45° phase shift between nodes in the ring oscillator so that a 90° output can be used for clock recovery processing and other edge alignment reasons.

TABLE 1
R-S Latch Delay Element Truth Table

| Mode of | | | | |
|---|---|---|---|---|
| Operation | S | R | Q | Qb |
| Prohibited | 0 | 0 | 1 | 1 |
| Set | 0 | 1 | 1 | 0 |
| Reset | 1 | 0 | 0 | 1 |
| Hold | 1 | 1 | No Change | No Change |

Operation of the circuit 100 is explained more fully with reference to the truth table of Table 1. From Table 1, a common mode signal of 11 at the SR input of the R-S latch delay element 120a holds the current value. Consequently, no change in the ring of R-S latch delay elements 120 occurs. A common mode 00 at the SR input of the R-S latch delay element 120a produces a 11 which is provided to the input of the R-S latch delay element 120b and holds the value. Similarly, a 00 or 11 input to R-S latch delay element 120a does not cause a state change. Consequently, the changed state does not propagate through the ring. Only 10 or 01 inputs provided to the R-S latch delay element 120a propagate around the ring oscillator, which performs as a digital equivalent to a differential mode analog circuit. Accordingly, the circuit 100 rejects common mode signals and gives a much improved power supply ripple rejection.

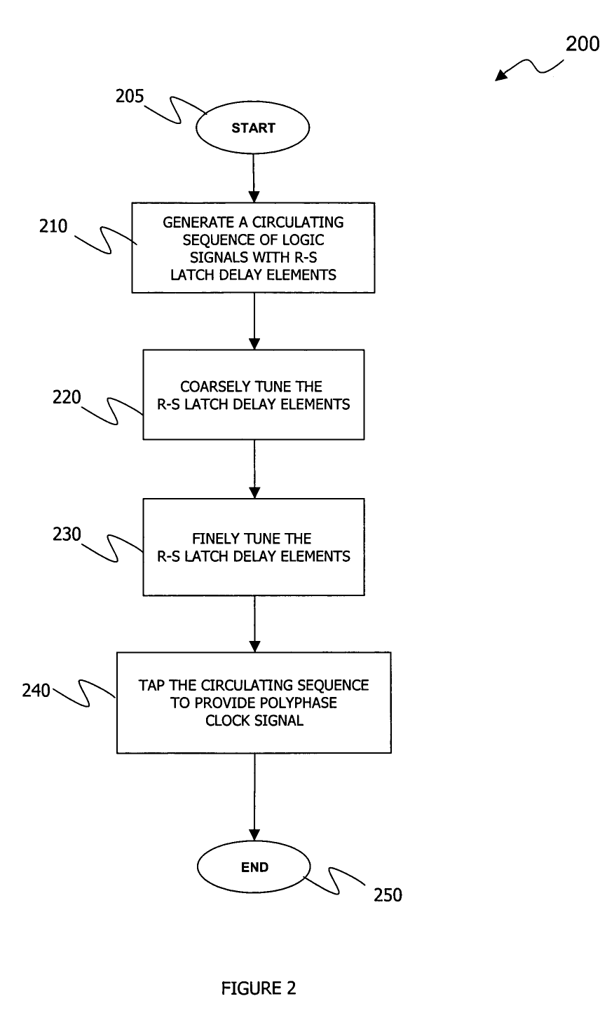

Turning now to FIG. 2, illustrated is a flow diagram of one embodiment of a method of generating a polyphase clock signal, generally designated 200, carried out according to the principles of the present invention. The method 200 begins with an intent to generate a polyphase clock signal.

After beginning, a circulating sequence of logic signals is generated with R-S latch delay elements connected in a ring in a step 210. The ring may include four R-S latch delay elements. Each of the R-S latch delay elements may provide a phase shift of 45°. Accordingly, in some embodiments the circulating sequence covers a phase shift of 180° around the ring.

After transforming, the R-S latch delay elements are coarsely tuned in a step 220. The R-S latch delay elements may be conventional cross-connected NAND gates. A high supply voltage port of each NAND gate may be used as a coarsely tuning port. A coarsely tuning port control may be provided to the coarsely tuning port of each NAND gate by a conventional opamp. Coarsely tuning the R-S latch delay elements provides a coarse tuning for the polyphase clock signal.

After coarsely tuning, the R-S latch delay elements are finely tuned in a step 230. Fine tuning of the R-S latch delay elements may be provided by fine tuning ports coupled to an output of each NAND gate of the R-S latch delay elements. The fine tuning ports may be used to change the output impedance of the R-S latch delay elements to vary an output frequency of the polyphase clock signal. Thus, fine tuning the R-S latch delay elements allows fine tuning of the polyphase clock signal.

After finely tuning, the circulating sequence is tapped to provide the polyphase clock signal in a step 240. In some embodiments, the polyphase clock signal is composed of an in-phase signal and a quadrature phase signal. Of course, other taps may be provided to provide varying phase shifts. After providing the polyphase clock signal, the method 200 ends in a step 250.

While the method disclosed herein has been described and shown with reference to particular steps performed in a particular order, those skilled in the pertinent art will understand that these steps may be combined, subdivided, or reordered to form an equivalent method without departing from the teachings of the present invention. Accordingly, unless specifically indicated herein, the order and/or the grouping of the steps are not limitations of the present invention.

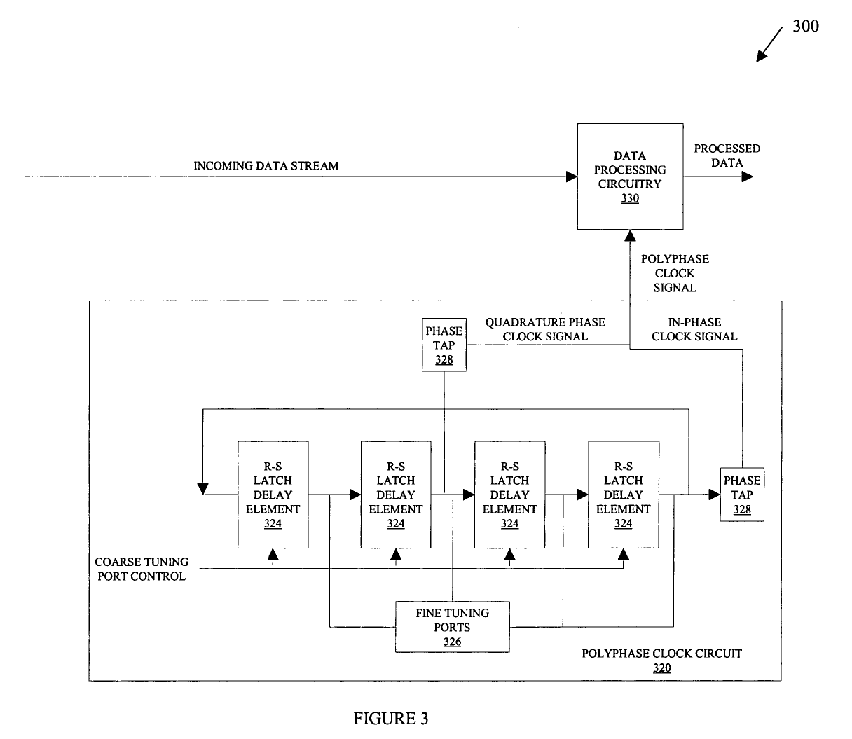

Turning now to FIG. 3, illustrated is a block diagram of a synchronous data processing system, generally designated 300, incorporating the circuit of FIG. 1 or the method or FIG. 2. The synchronous data processing system 300 includes a polyphase clock circuit 320 and data processing circuitry 330.

The synchronous data processing system 300 is configured to receive an incoming stream of data and synchronously process the data. To process the data synchronously, the synchronous data processing system 300 may recover a degraded clock signal from the incoming data stream. The degraded clock signal represents a clock signal used to transmit the data stream. The polyphase clock circuit 320 may provide a polyphase clock signal that is employed to recover the degraded clock signal for synchronous processing of data from the incoming data stream. The synchronous data processing system 300, for example, may be employed in a cellular telephone to synchronously process wirelessly received data.

The polyphase clock circuit 320 functions as the circuit 100 of FIG. 1 to provide the polyphase clock signal. The polyphase clock circuit 320 includes R-S latch delay elements 324, fine tuning ports 326 and phase taps 328. Each of these components are configured and operate as the R-S latch delay elements 120, fine tuning ports 130 and phase taps 140 of the circuit 100. Only two phase taps 328 of the polyphase clock circuit 320, however, are illustrated to indicate an in-phase component and a quadrature phase component of the polyphase clock signal. Of course, one skilled in the pertinent art will understand that additional phase taps 328 may be employed to provide other phase shifts. Typically, the polyphase clock signal is in synch with the transmit clock signal.

The data processing circuitry 330, coupled to the polyphase clock circuit 320, is configured to receive the incoming data stream and employ the polyphase clock signal to process the data synchronously. As discussed above, the data processing circuitry 330 may employ the polyphase clock signal to recover a degraded clock signal to use for synchronous processing. In other embodiments, the data processing circuitry 330 may not recover a clock signal but solely use the polyphase clock signal to insure synchronous processing. The data processing circuitry 330 includes conventional components commonly employed to process digital data. One skilled in the art will understand the operation and configuration of the data processing circuitry 330.

In summary, the present invention advantageously employs R-S latch delay elements instead of inverters to form an improved VCO for generating and recovering a clock signal. By employing the R-S latch delay elements, the present invention provides a wide linear frequency tuning range and reduces sensitivity to signals on a power supply compared to conventional VCOs. Additionally, the present invention provides other advantages, such as, rail-to-rail operation allowing robustness to convert from one technology node to a next technology node, lower switching current spikes on the voltage supply, wide oscillator voltage swings allowing easier conversion to logic levels, a separate coarse tuning and fine tuning port are easily implemented and a 50% duty cycle with a lower power consumption.

Although the present invention has been described in detail, those skilled in the art should understand that they can make various changes, substitutions and alterations herein without departing from the spirit and scope of the invention in its broadest form.

What is claimed is:

1. A circuit for generating a polyphase clock signal, comprising:
R-S latch delay elements connected in a ring and configured to generate a circulating sequence of logic signals; and
phase taps, coupled to points between ones of said R-S latch delay elements and configured to tap said circulating sequence to provide said polyphase clock signal.

2. The circuit as recited in claim 1 wherein four of said R-S latch delay elements are connected in said ring.

3. The circuit as recited in claim 1 wherein at least one of said R-S latch delay elements includes a coarse tuning port.

4. The circuit as recited in claim 1 further comprising a fine tuning port coupled to at least one of said R-S latch delay elements.

5. The circuit as recited in claim 1 wherein said polyphase clock signal is composed of an in-phase signal and a quadrature phase signal.

6. The circuit as recited in claim 1 wherein said circulating sequence covers a phase shift of 180° around said ring.

7. A method of generating a polyphase clock signal, comprising:
generating a circulating sequence of logic signals with R-S latch delay elements connected in a ring; and
tapping said circulating sequence to provide said polyphase clock signal.

8. The method as recited in claim 7 wherein four of said R-S latch delay elements are connected in said ring.

9. The method as recited in claim 7 further comprising coarsely tuning said polyphase clock signal.

10. The method as recited in claim 7 further comprising finely tuning said polyphase clock signal.

11. The method as recited in claim 7 wherein said polyphase clock signal is composed of an in-phase signal and a quadrature phase signal.

12. The method as recited in claim 7 wherein said circulating sequence covers a phase shift of 180° around said ring.

13. A synchronous data processing system, comprising:
a polyphase clock circuit, including:
R-S latch delay elements connected in a ring and configured to generate a circulating sequence of logic signals, and
phase taps, coupled to points between ones of said R-S latch delay elements and configured to tap said circulating sequence to provide a polyphase clock signal; and
data processing circuitry coupled to said polyphase clock circuit and configured to receive an incoming data stream and employ said polyphase clock signal to process said incoming data stream synchronously.

14. The system as recited in claim 13 wherein four of said R-S latch delay elements are connected in said ring.

15. The system as recited in claim 13 wherein at least one of said R-S latch delay elements includes a coarse tuning port.

16. The system as recited in claim 13 further comprising a fine tuning port coupled to at least one of said R-S latch delay elements.

17. The system as recited in claim 13 wherein said polyphase clock signal is composed of an in-phase signal and a quadrature phase signal.

18. The system as recited in claim 13 wherein said circulating sequence covers a phase shift of 180° around said ring.

19. The system as recited in claim 13 wherein said data processing circuitry employs said polyphase clock signal to recover a clock signal from said incoming data stream.
